(19) United States
(12) Patent Application Publication
(10) Pub. No.: US 2025/0006206 A1
(43) Pub. Date: Jan. 2, 2025

(54) WEARABLE SPEECH THERAPY DEVICE

(71) Applicant: Quadralynx, Inc., Spokane, WA (US)

(72) Inventors: Mark VanDam, Spokane, WA (US); Gavin La Rowe, Spokane, WA (US)

(21) Appl. No.: 18/755,471

(22) Filed: Jun. 26, 2024

Related U.S. Application Data
(60) Provisional application No. 63/524,661, filed on Jul. 1, 2023.

(51) Int. Cl. G10L 17/26; G10L 25/90

(52) U.S. Cl. CPC G10L 17/26; G10L 25/90

(57) ABSTRACT

A speech therapy device includes a first microphone, a second microphone, and output components. The speech therapy device receives first audio data from the first microphone and second audio data from the second microphone. The first audio data and the second audio data are associated with a sound captured in an environment of the speech therapy device. The speech therapy device determines, based at least in part on the first audio data and the second audio data, that the sound is associated with user speech of the user. Based at least in part on the sound being associated with the user speech, the speech therapy device determines one or more characteristics associated with the user speech, and determines that the one or more characteristics are indicative of hypophonia. When the one or more characteristics are indicative of hypophonia, the speech therapy device outputs a notification via the output components.

### CROSS-REFERENCE TO RELATED APPLICATIONS

This application claims priority to U.S. Provisional Patent Application No. 63/524,661, filed Jul. 1, 2023, entitled “Wearable Speech Therapy Devices and Methods for Treating Speech Pathologies, Including Hypophonia associated with Parkinson's Disease,” the entirety of which is herein incorporated by reference.

### BACKGROUND

Speech pathologies remain poorly managed and undertreated. Even though many modern tools and disciplines have emerged to allow for innovation in this field, the response to develop and implement improved management and treatment tools for speech disorders has lagged well behind technical advances and remains insufficient. For example, management and treatment of speech pathologies have often focused on costly and time-consuming in-person therapy from a speech pathologist. However, a large percentage of patients do not receive treatment because of the costs and logistical challenges associated with in-person therapy. Additionally, in-person therapy is often based on subjective clinical observations and descriptions. As such, current methods and tools for effective speech therapy are outdated, ineffective, and limited.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features. The systems depicted in the accompanying figures are not to scale and components within the figures may be depicted not to scale with each other.

FIG. 1 illustrates an example wearable speech therapy device for processing user speech and providing feedback to a user, according to examples of the present disclosure.

FIG. 2A illustrates an isometric view of the wearable speech therapy device of FIG. 1, according to examples of the present disclosure.

FIG. 2B illustrates a front view of the wearable speech therapy device of FIG. 1, according to examples of the present disclosure.

FIG. 3 illustrates an example process in which the wearable speech therapy device FIG. 1 provides feedback to the user, according to examples of the present disclosure.

### DETAILED DESCRIPTION

This application is directed, at least in part, to a wearable speech therapy device that may detect, treat, manage, and/or prevent atypical speech and/or behavior. As used herein, “atypical speech and/or behavior” is intended to cover human behavior, whether volitional or not, primarily speech and language acts, that are non-normal, non-canonical, atypical, disordered, characteristic of disability/disease, or impaired. The term is intended to encapsulate speech and language, such as reading, perception, production, communication, and associated behaviors. In an embodiment, the wearable speech therapy device may receive audio data, such as speech from a user, and process the audio data to provide real-time therapeutic feedback to the user. For example, based on processing the audio data, the wearable speech therapy device may output notification(s) that prompt the user to adjust characteristics of their speech (e.g., tone, prosody, duration, amplitude, etc.). The wearable speech therapy device may continuously capture and process the audio data to provide real-time feedback in a corrective and therapeutic manner. In an embodiment, the wearable speech therapy device may process the audio data to detect low-volume (e.g., low amplitude) speech, such as low-volume speech associated with hypophonia. Users employing the wearable speech therapy device may experience increased speech perceptibility, improved speech production, independence, quality of life, productivity, and mental health.

In an embodiment, and as will be explained herein, the wearable speech therapy device may determine speech and/or vocal biomarkers associated with the audio data for detecting atypical speech. The speech and/or vocal biomarkers may be compared to reference characteristics, thresholds, etc., to detect when the speech is indicative of atypical speech. For example, the wearable speech therapy device may detect one or more speech and/or vocal biomarkers associated with hypophonia, which may be characterized by low-amplitude speech (e.g., hypophonic speech biomarkers). Atypical speech may also be characterized by breathy and hoarse vocal quality, reduced loudness, and/or reduced pitch and loudness variability.

In an embodiment, atypical speech may be associated with a variety of diseases and health-care-related conditions, including Parkinson's disease, Alzheimer's disease, Frontotemporal dementia, Vascular dementia, ALS/Lou Gehrig's disease, hereditary Prior disease, congenital defects, conditions elicited or exacerbated by certain medications, and various forms of injury (e.g., injuries affecting the central nervous system (CNS), including the brain, and trauma impairing vocal anatomy or neuromotor function). In an embodiment, the wearable speech therapy device may associate the speech and/or vocal biomarkers with certain diseases, diagnoses, etc. The wearable speech therapy device may be used for other speech pathological, behavioral, psychomotor, and movement disorders, prodromal symptoms associated with disease or disorder, and pathogenic conditions.

In an embodiment, the wearable speech therapy device may be a compact device worn on a body of the user. The wearable speech therapy device may be worn in any manner by the user such as in the form of bracelets, watches, stick-on arrays, eyeglasses, caps, hearing aids, brooch, ties, lanyards, earrings, etc. The wearable speech therapy device may include suitable attachment mechanisms, such as hook and loop, clasps, magnets, cords, chains, etc., for coupling (e.g., pinning, hanging, etc.) in any manner to the user. However, although described herein as being a wearable device worn by the user, in an embodiment, the techniques described herein for treating, detecting, managing, and/or preventing atypical speech may not be limited to such wearable devices. For example, a device (e.g., stand-alone device, integrated device, etc.) employing the techniques described herein may be placed on a shelf, counter, wall, etc., within an environment in which the user resides or occupies.

The wearable speech therapy device may include a housing in which components of the wearable speech therapy device are disposed. The housing may include any shape, such as an elongated cylindrical housing. The housing may be manufactured from any suitable materials, such as plastics, composites, metal, etc., and using any manufacturing process(es), such as injection molding, stamping, blow molding, etc. The housing may also be contaminate-resistant to prevent the ingress of liquid, dust, or contaminants into the housing. Additionally, the wearable speech therapy device may include suitable processing and internal components to detect, treat, manage, and/or prevent atypical speech. For example, the wearable speech therapy device may include sensor(s), microphone(s), battery (ies), processing components (e.g., processors, memory, system on a chip (SoC) or integrated circuits (IC), etc.), etc. disposed within the housing.

In an embodiment, one or more button(s) may be included to control one or more operation(s) of the wearable speech therapy device. The button(s) may be used to power on/off the wearable speech therapy device, mute the wearable speech therapy device, change setting(s) of the wearable speech therapy device, connect to nearby devices, etc. A user interface may functionality allow the user to interface with the wearable speech therapy device. The user interface may include an organic light emitting diode (O/LED), (in-plane switching [IPS] or thin-film-transistor [TFT]) liquid crystal display (LCD), laser video display (LVD), vibrotactile, haptic, or other applications.

The wearable speech therapy device may include any number of sensor(s) disposed about or within the housing for detecting when the user speaks, voice and speech quality and quantity, environmental sensor input including non-speech acoustic input, and/or when the user is mute (e.g., not speaking). Using the sensor(s), the wearable speech therapy device may determine the speech and/or vocal biomarkers associated with the user's speech. For example, the wearable speech therapy device may include microphone(s) for collecting audio signals associated with the user's speech. The audio signals may be processed as data, which is analyzed to determine the speech and/or vocal biomarkers. The wearable speech therapy device may include analog and digital converters in the capture, processing, and storage of signals sampled from the sensors. The signals from the microphone(s) and sensor(s) may be stored in a dataset that includes raw and/or normalized or transformed acoustic wave values.

In an embodiment, the microphone(s) may include at least two microphones spaced apart from one another within the housing. For example, the housing may include a first end and a second end spaced apart from the first end. A first of the microphones may be located closer to the first end than the second end, while a second of the microphones may be located closer to the second end than the first end. Any number of microphones, however, may be included within the wearable speech therapy device. The microphone(s) may be used for determining the directionality (e.g., time of flight, velocimetry, time-delay analytics, etc.) of the signal and/or whether the signal corresponds to the speech of a user wearing the wearable speech therapy device. For example, the microphone(s) may receive respective audio signals that are representative of sounds within the environment. When worn by the user, the microphones may be spaced apart by different distances from sound sources of the user (e.g., a mouth of the user). For example, when the wearable speech therapy device represents a device that hangs from a neck of the user (e.g., as a necklace), the microphones may be located at different distances from the mouth of the user. As such, as the microphone(s) are spaced apart by a different distance from the mouth of the user, user speech may be discerned from other sources of sound within the environment of the user.

In an embodiment, other sensors of the wearable speech therapy device, such as piezoelectric sensors, accelerometers, Hall sensors, passive infrared (PIR) sensors, etc., may receive signals that are processed to accumulate and analyze sensor data that is used to determine when the user speaks, user behavior, and/or which is used to determine the speech and/or vocal biomarkers. Still, sensors may additionally or alternatively include global positioning satellite (GPS), gyroscope(s), inertial measurement units (IMU), etc. In an embodiment, GPS may record a location and/or track at-risk users (e.g., persons with dementia) and/or be used to calibrate the wearable speech therapy device (e.g., at different elevations, acoustic environments, language locales, environmental concerns, etc.). The gyroscope, IMU, and/or Hall sensor may be used to detect and alert third parties in the event of falls or accidents. The sensor data generated from the sensor(s), such as an IMU, may be used to determine when the user speaks, for example, based on experienced vibrations, accelerations, inhaling/exhaling, pressure changes, and so forth.

The wearable speech therapy device may employ voice activity detection (VAD) to determine the speech of the user or to recognize sounds generated by the user or other talkers. VAD may be used to recognize the speech or behavior of the user as compared to other sounds within an environment of the user (e.g., background noise, speech from other persons in the environment, etc.). For example, the wearable speech therapy device may include a VAD component to perform VAD techniques on the audio data (or audio signals) captured by the microphones. The VAD component may utilize one or more VAD algorithms based on channel energy with long and short-term energies, sub-band long and short-term energies with combination logic, Deep Neural Network (DNN) based VADs, or any other type of VAD algorithms, with shaped and/or hangover windows, to determine whether the audio data is representative of user speech. VAD is representative of one technique to detect speech and laryngeal activity in a signal. Other techniques exist to detect, segregate, label, and classify target speech, other vocalizations, and non-speech vocalizations. For example, statistical likelihood pattern-matching models may also be employed using diphone, triphone, or phone templates. The wearable speech therapy device may additionally or alternatively employ modern methods of talker identification and (target) talker identification.

The audio signals generated by the microphones may be cross-correlated. For example, cross-correlation may applied between audio signals detected by the microphones to determine a time difference of arrival (TDOA) for the correlated signals. In other words, the differently spaced microphones from the mouth of the user have different time of arrival (TOA) values. This allows the calculation of an angle from which the detected signals originate relative to a line intersecting the two microphones. Because the mouth of the user is approximately in line with the two microphones (e.g., when the wearable speech therapy device is worn as a necklace), a threshold may be applied on the TDOA, and when the TDOAs exceed this threshold, the audio signals may be determined to be speech of the user, and non-speech sound, behavior of users or others, or speech of another talker.

Once the user speech is determined, using VAD, for example, the audio signals may be further processed. For example, given that the wearable speech therapy device may be used in a plurality of diverse environments of the user, user speech may be detected based on a signal-to-noise ratio (SNR). To determine SNR, a decibel level of the speech of the user is determined, and the decibel level of the speech of the user is subtracted from a decibel level of a background or non-target-user information. In an embodiment, the decibel level of the user may be determined by the following equation.

$$10 \frac{dB}{10} = 10 \frac{dB e}{10} + 10 \frac{dBu}{10} \qquad ( 1 )$$

where:
dB represents the current decibel reading (which includes the speech of the user and environmental noise;
dBe represents the decibel level of the environment, and
dBu represents the decibel level of the user.

Subsequently, a signal to noise (SNR) ratio may be determined by the following equation.

$$SNR = dBu - dB e = 10 ( log ( \frac{dB - dB e}{10} ) - 1 ) \qquad ( 2 )$$

where:
dBe represents the decibel level of the environment, and
dBu represents the decibel level of the user.

In an embodiment, the decibel level of the user and the decibel level of the environment may be determined by calibrating the microphone closest in proximity to the mouth of the user and using a sound level meter. The microphone may be placed next to a sound level meter, and the log of the root mean square (logRMS) may be recorded over an interval of time (e.g., 0.5 seconds), along with a corresponding decibel reading on the sound level meter. Once data is collected over the decibel range of interest (e.g., 40-70 dB), a linear regression is applied to obtain a function that takes logRMS input and outputs decibel values. Using this calculation, the decibel level of the environment may be determined by averaging the decibel readings over a specified time frame (e.g., 2 seconds, 3 seconds, etc.) of noise that was determined to be environmental noise as calculated by equation (2) above. Further, the time analysis window may be empirically determined, user-specific, dynamic, adjustable, and/or modulated according to other factors. The time window may be modulated to affect performance according to user needs. For example, if the user is in a known noisy environment, such as a public event, the time window may be adjusted to make the performance of the wearable speech therapy device more or less sensitive. The audio data may be analyzed after determining SNR to improve VAD and/or accuracy in detecting hypophonia.

However, as noted above, sensor data generated by the sensor(s) may be used in combination with the audio data to determine when the user is speaking. For example, the sensor(s) may detect vocal vibrations by detecting changes in pressure, acceleration, temperature, strain, or force. Times associated with generating the audio data and the sensor data may be associated with one another to correlate the sensor data with the audio data. To effectively detect vocalization, the sensor(s) may be positioned in proximity to the clavicle or thyroid/cricoid cartilage or near vocal folds of the user to better detect movement or pressure changes associated with vocalization.

Once speech of the user is detected, the audio data and/or sensor data may be analyzed to determine characteristics of the user speech. The characteristics may include the speech and/or vocal biomarkers, where the speech and/or vocal biomarkers may identify or be associated with characteristics of the user speech. In an embodiment, the speech and/or vocal biomarkers may be associated with how the user speaks, such as pitch, intonation, tone, pauses, phonation, and/or changes associated with the user's speech. The language, speech, and/or vocal biomarkers may also include features such as articulation, decreased energy in the higher parts of a harmonic spectrum, imprecise articulation of vowels and consonants, fundamental frequency, voicing, windowed and absolute syllable/sonorant-peak rates, SNR, temporal and spectral voice characteristics, frequency, spectral/cepstral cues, vocal quality/stability (e.g., shimmer, jitter, harmonic to noise ratio), prosody, temporal output, amplitude stability, and/or motor processes.

In an embodiment, the speech and/or vocal biomarkers may be associated with certain portions of the user speech. For example, when the user pauses during speech, portions of the user speech that include the pauses may be identified (e.g., via metadata). In an embodiment, the speech and/or vocal biomarkers may be characterized by duration, frequency, decibel level, amplitude, energy, etc. Although described as speech and/or vocal biomarkers, the sensor data captured by the sensor(s) may be used to determine the speech and/or vocal biomarkers associated with the user's speech. Additionally, the speech and/or vocal biomarkers may be stored to provide pathology estimation and behavioral characteristics, and sample comparative algorithms may be used to diagnose, qualify, classify, quantify, and monitor the speech pathological condition, status, and therapeutic progress.

In an embodiment, the wearable speech therapy device may analyze the audio data, the sensor data, and/or the SNR to determine the speech and/or vocal biomarkers for use in detecting atypical speech, such as low-volume speech associated with hypophonia. The amplitude of the user speech may be compared to one or more thresholds. In an embodiment, the thresholds may be based at least in part on the SNR and/or the user and may be dynamically determined. For example, if the amplitude associated with user speech is less than the threshold, the wearable speech therapy device may detect and classify hypophonia. Comparatively, if the user speech is greater than the threshold, hypophonia may not be detected and classified as such. In an embodiment, the wearable speech therapy device may determine any number of speech and/or vocal biomarkers for detecting atypical speech, such as hypophonia in the user's speech. The speech and/or vocal biomarkers may be compared to respective thresholds to determine whether the speech and/or vocal biomarkers are indicative of hypophonia. The speech and/or vocal biomarkers, in addition to indicative low volume and known pathologies of the speech production physiology, may also include other vocal and acoustic features and values, both normal/typical and pathological, to improve operative flexibility and accuracy and therapeutic utility of the wearable speech therapy device.

In an embodiment, the speech and/or vocal biomarkers may be compared to reference characteristics of speech from users with hypophonia as well as from users without hypophonia. Through this comparison, a statistical likelihood may be determined whether the speech and/or vocal biomarkers are indicative of hypophonia or not indicative of hypophonia. In an embodiment, the wearable speech therapy device may determine voice fingerprints or vocal phenotype. The use of the voice fingerprints may increase an accuracy in detecting speech of the user, or discerning speech of the user from other sounds emanating within the environment. Moreover, the voice fingerprints may be used to more accurately detect atypical speech, such as hypophonia. For example, in an embodiment, the speech and/or vocal biomarkers may be used to generate voice fingerprints associated with the user, and the voice fingerprint may be analyzed to determine whether the voice fingerprint is associated with or includes hypophonia. The voice fingerprint may characterize the user speech. In an embodiment, the voice fingerprint may be compared to one or more reference fingerprints to detect hypophonia. In addition to fingerprints of target speech behavior, other audio and acoustic fingerprint/phenotype biomarkers may be used in the wearable speech therapy device. For example, characteristic environmental auditory events such as crowd noises, door slamming, and household implements (e.g., blender, toilet flushing, alarms, etc.) have unique acoustic signatures that may be used in combination or solely to better interpret the auditory and acoustic environment of the wearable speech therapy device or the user. There may be audio or acoustic biomarkers or enviro-markers used in the determination and classification of signals.

The wearable speech therapy device may output the notification(s) in an attempt to signal the user to correct their speech and/or behavior. The notification(s) may be output in real-time or substantially real-time to provide near-instantaneous feedback to the user to correct their speech and/or behavior. In an embodiment, the notification(s) may be audible, visual, olfactory, electronic, haptic, and/or any combination thereof. For example, the wearable speech therapy device may include a speaker that outputs audio (e.g., deeps, tones, instructions, etc.), lighting elements that illuminate (e.g., patterns, colors, etc.), and/or a motor that vibrates to prompt the user to correct their speech. By outputting the notification(s), the wearable speech therapy may provide real-time therapeutic assistance to alert the user to correct their speech and/or behavior. For example, the notification(s) may prompt or inform the user to raise the volume of their speech. The wearable speech therapy device may output the notification(s) for a predetermined amount of time, continuously, and/or until the speech and/or behavior of the user is corrected. Using this feedback, the user may raise the volume of their speech, and the wearable speech therapy device may subsequently capture additional audio data and/or sensor data that is analyzed to determine whether the user has corrected their speech and/or behavior. As such, the notification(s) may serve to signal the user to correct their speech and/or behavior based on objective measurements. In addition to real-time feedback as described above, asynchronous reports may also be delivered to the user and stored in the software. For example, a daily histographic digest of performance and behavior may be delivered via email or via software (e.g., a mobile application) to the user for offline use. Performance data may also be delivered to a database collection performance characteristics from many users, constituting the basis for additional software and algorithm changes. The application and/or software may be embedded into the hardware/device or may be external software capable of being instantiated into external hardware such as a mobile phone, tablet, or computer.

In an embodiment, the wearable speech therapy device may tailor the notification(s) based on one or more preference(s) stored in association with a user profile of the user. For example, the user profile may indicate a type of notification(s) to output, as well as their associated intensity (e.g., volume, luminosity, etc.), duration, type (e.g., sound-haptic-sound), patterns (e.g., low haptic-medium haptic-low haptic, etc.), combinations thereof, etc. The wearable speech therapy device may access the preference(s) as stored in the user profile when outputting the notification(s).

In addition to processing the audio data and/or the sensor data for detecting speech and behavioral disorder, the wearable speech therapy device may utilize other data. For example, the wearable speech therapy device may have access to user data stored within a user profile of the user. The user data may indicate demographics of the user (e.g., sex, age, disease state, audiological status, medical history, occupation, residence and care data, socioeconomic status, etc.), environmental factors (e.g., time of day, medication schedule, auditory and acoustic environment, etc.), a schedule of the user (e.g., when the user is sleeping, working, exercise, eating, socially interacting, etc.), medications of the user (e.g., medication type and medication schedules), etc. This user data may additionally, or alternatively, be used to treat, detect, manage, and/or prevent atypical speech and/or behavior such as hypophonia. For example, incorporating user-specific, treatment-related, non-vocal data may be used to more effectively treat, manage, and/or prevent hypophonia. Another example is using data or user input to aid the user in scheduling appointments or follow up visits with health care providers (e.g., speech language pathologist, physician, occupational or physical therapist, dentist, neurologist, or similar) or other professionals. The wearable speech therapy device and software may, based on inputs, give suggestions, advice, or recommendations including referrals based on data from user or database information. The wearable speech therapy device may also afford the user to interact with their existing disease specialist for monitoring or services.

In an embodiment, the wearable speech therapy device may utilize artificial intelligence (AI) and/or machine-learning (ML) model(s) to detect speech or behavioral characteristics. To clarify, AI and ML techniques, which are described and detailed with examples below, are used as encompassing cover terms for “smart” and algorithmic collection, processing, analyzing, databasing, managing, summarizing, and using data in an automated and large-scale fashion, in this case frequently speech and behavioral data. The ML model(s) may be trained from a database (e.g., historical data, such as audio data that includes atypicality such as hypophonia and/or typical speech and behavior normalized data) to analyze the audio data captured by the sensor(s) and microphone(s) for identifying the speech and/or vocal biomarkers. The ML model(s) may also be trained from other sensor data that was indicative of atypicality and/or where atypicality was not present. The ML model(s) may determine speech and/or vocal biomarkers and may assess the speech and/or vocal biomarkers in comparison to information stored in the database (e.g., reference characteristics, reference voice fingerprint, etc.) to determine whether atypicality was detected in the user speech and/or behavior.

As part of the ML model(s) analyzing the audio data and/or the sensor data, the ML model(s) may label the characteristic(s) of the speech and/or behavior, for example, the speech and/or vocal biomarkers, to indicate whether the characteristic(s) are associated with atypicality. In an embodiment, an output of the ML model(s) may indicate whether the speech contains hypophonia. In an embodiment, the ML model(s) may determine the characteristics(s) for comparison to respective references for determining whether the speech contains hypophonia or is free of hypophonia. The ML model(s) may use any number of characteristic(s) for determining whether the speech contains hypophonia or is free of hypophonia.

In an embodiment, the ML model(s) may generate scores that are associated with the characteristic(s) of the typical or atypical speech. For example, the ML model(s) may generate scores associated with the speech and/or vocal biomarkers. If the scores are greater than a threshold, the ML model(s) may have a threshold confidence that the speech is associated with disorder or atypicality. Atypicality may be assessed with regard to the model parameters, and a discrete or probabilistic classification will be generated. The classification may be stored, processed, and used for feedback (as needed).

In an embodiment, the wearable speech therapy device may be calibrated during or between uses. Calibration may yield more sensitive, situationally adjusted, and therapeutically useful when detecting atypicality. The calibration and sensitization may operate by combining, for example, detection and coordinate processing of vocal amplitude along with one or more discrete user voice characteristics (e.g., non-amplitude vocal biomarkers) for a user, during a use session or between use sessions, to refine or otherwise modify subsequent detection of user-specific speech pathological data for output the notification(s). Calibration may also involve detecting sound from other sources within the environment of the user, such as non-speech background noise (e.g., any substantial, persistent or intermittent background noise occurring in the environment, such as a television, appliances, etc.). For example, the wearable speech therapy device may detect sound from multiple sources, including the user and at least one non-user source, and through differential detection and/or processing, the wearable speech therapy device may self-adjust or calibrate, whether in real-time or throughout repeated use sessions to more accurately assign user vocal signals as user-originated, and more effectively distinguish third party and other background acoustic signals from sources other than the user.

Sounds generated from sources other than the user may be filtered to allow for more accurate detection of atypical speech and/or behavior. In an embodiment, the wearable speech therapy device may assign portions of the audio data as being user-originated and non-user-originated to more effectively detect atypicality, such as hypophonia. In an embodiment, the notification(s) may be based at least in part on a level of non-user-originated audio sources, for example, to inform the user that conversation or other background noise is occurring, requiring a greater correction of low-amplitude speech.

As described above, the wearable speech therapy device may provide real-time feedback to the user when atypical speech and/or behavior is detected. However, the wearable speech therapy device may record audio data over periods of time (e.g., hours, days, etc.) to provide a history of the user's speech. The audio data and/or the detection of atypical speech and/or behavior may be stored in association with the user profile, a database, etc. Such data may be used by the user, care provider, and/or a speech pathologist to further refine the therapeutic benefits made possible by the wearable speech therapy device. Moreover, the audio data and/or the sensor may be used to retrain the ML model(s), for example, to increase an accuracy of detecting user speech and/or atypical speech and/or behavior in future instances. The audio data and/or sensor data may also be stored in memory of the device and provided (e.g., downloaded) to other devices.

Although the wearable speech therapy device is described as processing the audio data and/or the sensor data, in an embodiment, the wearable speech therapy device may communicatively couple to one or more separate devices for processing the data. For example, the wearable speech therapy device may communicatively couple to a mobile device, laptop, etc. of the user, whereby the mobile device may process the audio data and/or the sensor data to determine the speech and/or vocal biomarkers for determining atypical speech and/or behavior. The wearable speech therapy device may send the audio data and/or the audio data to the mobile device for processing, and the mobile device may transmit notifications back to the wearable speech therapy device for output. Microphone(s) and/or sensor(s) of the mobile device may additionally or alternatively be used to detect atypical speech and/or behavior.

Additionally, the wearable speech therapy device and/or the mobile device may communicatively couple to remote computing resource(s) (e.g., cloud) for processing the collected data. Any level of split processing may be performed by the wearable speech therapy device, the mobile device, the remote computing resource(s), and/or other devices, systems, networks, etc. The wearable speech therapy device may include suitable network interface(s), such as Bluetooth, Cellular, Wi-Fi, etc. for communicatively coupling with such devices.

In an embodiment, the wearable speech therapy device may transition between states, such as an off/sleep state and an on/awake state. Transitioning between the states may conserve battery power of the wearable speech therapy device. For example, after a predetermined amount of time, or latent period (e.g., five or ten minutes) transpires without detected sounds, or VAD, the wearable speech therapy device may power off certain components (e.g., network interfaces, I/O components, etc.).

The present disclosure provides an overall understanding of the principles of the structure, function, device, and system disclosed herein. One or more examples of the present disclosure are illustrated in the accompanying drawings. Those of ordinary skill in the art will understand and appreciate that the devices, the systems, and/or the methods specifically described herein and illustrated in the accompanying drawings are non-limiting embodiments. The features illustrated or described in connection with one embodiment, or instance, may be combined with the features of other embodiments or instances. Such modifications and variations are intended to be included within the scope of the disclosure and appended claims.

Vocal amplitude may be determined based on detected values from the sensor(s) 116, which give both negative and positive values that are not normalized. To resolve these problems, the detected values are squared and then the square root is computed (to determine an absolute value from the combined negative and positive values) and these data are normalized to fit into an interpretable range. Raw vocal data from the sensor(s) 116 are typically channeled through an analog-to-digital converter (comprising a sensor transducer and a modulator). The sensor transducer receives raw data from a plurality of sensors. The analog-to-digital converter generates a set of raw data and normalized data comprising raw data and normalized acoustic wave data processed from each sensor. The processor receives the set of raw data and normalized data and processes it to generate processed speech and behavioral data, and based on processing results a user biofeedback signal is either generated or not generated.

In an embodiment, other examples of the sensor(s) 116 of the wearable speech therapy device 102, such as piezoelectric sensors, accelerometers, etc. may generate signals that are processed to generate sensor data 124 that is used to determine when the user 100 speaks, and/or which is used to determine the speech and/or vocal biomarkers 110. The sensor(s) 116 may additionally or alternatively include global positioning satellite (GPS), gyroscope(s), inertial measurement units (IMU), etc. The sensor data 124 generated from the sensor(s) 116, such as an IMU, may be used to determine when the user 100 speaks, for example, based on experienced vibrations, accelerations, inhaling/exhaling, pressure changes, and so forth. The sensor(s) 116 may be calibrated to optimize function and increase processing fidelity. The sensor data 124 collected by the sensor(s) 116 may be used in combination with the audio data 104 to determine when the user 100 is speaking. Timestamps associated with the audio data 104 and the sensor data 124 may be associated with one another to correlate the sensor data 124 with the audio data 104. To effectively detect vocalization, the sensor(s) 116 may be positioned in proximity to the clavicle or thyroid/cricoid cartilage, or near vocal folds of the user 100 to better detect movement or pressure changes associated with vocalization.

Once user speech 106 is detected, the audio data 104 and/or sensor data 124 may be analyzed to determine the speech and/or vocal biomarkers 110. In an embodiment, the speech and/or vocal biomarkers 110 may be associated with how the user 100 speaks, such as pitch, intonation, tone, pauses, phonation, changes associated with the user speech 106, articulation, decreased energy in the higher parts of a harmonic spectrum, imprecise articulation of vowels and consonants, fundamental frequency, voicing, windowed and absolute syllable/sonorant-peak rates, SNR, temporal and spectral voice characteristics, frequency, spectral/cepstral cues, vocal quality/stability, prosody, temporal output, and amplitude stability, and/or motor processes. In an embodiment, the speech and/or vocal biomarkers 110 may be associated with certain portions of the user speech 106. For example, when the user 100 pauses, portions of the user speech 106 (or the audio data 104) that include the pauses may be identified (e.g., via metadata). In an embodiment, the speech and/or vocal biomarkers 110 may be characterized by duration, frequency, decibel level, amplitude, energy, etc.

In an embodiment, the wearable speech therapy device 102 may process the audio data 104 and/or the sensor data to detect low-volume (e.g., low amplitude) speech, such as low-volume speech associated with hypophonia or other atypical speech and/or behavior. The low-volume speech, for example, may be indicated within the speech and/or vocal biomarkers 110. The speech and/or vocal biomarkers 110 may indicate an amplitude of the user speech 106, and the amplitude of the user speech 106 may be compared to one or more thresholds or reference characteristic(s) indicated of low-volume speech associated with hypophonia. In an embodiment, the thresholds may be based at least in part on SNR calculated form the audio and/or specific(s) of the user 100 (e.g., baseline volume). In an embodiment, the threshold(s) to which the amplitude of the user speech 106 is compared, or more generally the threshold(s) to which the speech and/or vocal biomarkers 110 are compared, may be dynamically determined.

As an example, if an amplitude associated with user speech 106 is less than the threshold, the wearable speech therapy device 102 may detect hypophonia. Comparatively, if the amplitude of the user speech 106 is greater than the threshold, hypophonia may not be detected. In an embodiment, the wearable speech therapy device 102 may determine any number of the speech and/or vocal biomarkers 110 for comparison to respective thresholds for detecting hypophonia in the user speech 106. In this manner, the speech and/or vocal biomarkers 110 may be compared to reference characteristics of speech from users with hypophonia as well as from users without hypophonia. Through this comparison, a statistical likelihood may be determined whether the speech and/or vocal biomarkers 110 are indicative of hypophonia, or not indicative of hypophonia.

In an embodiment, the wearable speech therapy device 102 may determine voice fingerprint(s) 126 (or phenotype). The use of the voice fingerprint(s) 126 may increase an accuracy in detecting the user speech 106, or discerning speech of the user 100 from other sounds emanating within the environment. Moreover, the voice fingerprint(s) 126 may be used to more accurately detect atypical speech and/or behavior within the user 100. For example, in an embodiment, the speech and/or vocal biomarkers 110 may be used to generate voice fingerprint(s) 126 (e.g., audio signatures, acoustic fingerprint, voice signature, voiceprint, etc.) associated with the user 100, and the voice fingerprint(s) 126 may be analyzed to determine whether the voice fingerprint(s) 126 is associated with, or includes, disordered speech or behavior. Generally, tythe voice fingerprint(s) 126 may characterize the user speech 106. In an embodiment, the voice fingerprint(s) 126 may be compared to one or more reference fingerprints to detect atypical and/or disordered speech or behavior. For example, the voice fingerprint(s) 126 may be compared against reference audio voiceprints associated with hypophonia. Each voice fingerprint(s) 126 may indicate speech and/or vocal biomarkers 110, and if a similarity between the voice fingerprint(s) 126 and a stored reference audio voiceprint exists, hypophonia may be detected.

In an embodiment, the wearable speech therapy device 102 may output notification(s) 128 in instances where atypical speech and/or behavior is detected and/or where atypical speech and/or behavior is not detected. The notification(s) 128 may provide feedback to the user 100 in a therapeutic manner, thereby assisting the user 100 in speech therapy. For example, if atypical speech and/or behavior is not detected, the notification(s) 128 may provide indications of such, thereby informing the user 100 of their proper speech. Comparatively, if atypical speech and/or behavior is detected, the notification(s) 128 may provide indications of such, thereby informing the user 100 to correct or modulate their speech. The notification(s) 128 may be output in real-time, or substantially real-time, to provide near-instantaneous feedback to the user 100.

In an embodiment, the notification(s) may be associated with the speech and/or vocal biomarkers 110 that are detected. For example, if the user speech 106 has a low-amplitude, the notification(s) 128 may indicate such. As another example, if the user speech 106 is indicative of stammering, the notification(s) 128 may indicate such. As yet another example, if the user speech 106 is not well articulated (e.g., slurring), etc. the notification(s) 128 may indicate such. As such, the notification(s) 128 may convey specific information and/or prompts to the user 100 to correct their speech.

In an embodiment, the notification(s) 128 may be audible, visual, haptic, and/or a combination thereof. The wearable speech therapy device 102 may include I/O component(s) 130 that output the notification(s) 128. For example, lighting elements (e.g., LEDs) may signal the user 100 by outputting light at different brightness levels, flashing at different durations, frequencies and/or specific sequences (e.g., numeric sequences of long and short flashes) in different modes, and/or by lighting in different colors. Speaker(s) may output an audible signal, such as a continuous prompt tone, sounding at different pitches or loudness in different modes, sounding at different durations, frequencies and/or specific sequences (e.g., numeric sequences of loud and soft, or high and low pitch sounds) in different modes. In an embodiment, the speaker may additionally or alternatively be activated to provide programmed voice instructions to the user 100, for example, to provide more specific and personalized speech therapy instructions (e.g., prompting the user 100 “low speech detected, speak up please”, or “high background noise detected”, etc.)

The notification(s) 128 may also be output by a haptic motor. For example, the haptic motor may vibrate to prompt the user 100 via a continuous tactile stimulus. The vibration may be low, medium or high intensity, by intermittent tactile stimuli of different durations, frequencies and/or specific sequences (e.g., numeric sequences of intermittent tactile stimuli differing in periodicity and/or intensity) to communicate specific information/prompts to the user 100.

Other output components of the wearable speech therapy device may include displays, touch-screens, etc. Example input devices may include button(s), switches, toggles, etc.

By outputting the notification(s) 128, the wearable speech therapy device 102 may provide real-time therapeutic assistance to alert the user 100 to correct their speech. For example, the notification(s) 128 may prompt or inform the user 100 to raise their volume. The wearable speech therapy device 102 may output the notification(s) 128 for a predetermined amount of time, continuously, and/or until the user speech 106 is corrected. For example, using the feedback provided by the notification(s) 128, the user may raise their volume. The wearable speech therapy device 102 may subsequently capture the audio data 104 and/or sensor data 124 that is analyzed to determine whether the user 100 has corrected their speech. As such, the notification(s) 128 may serve to signal the user to correct their speech based on objective measurements.

In an embodiment, the wearable speech therapy device 102 may tailor the notification(s) 128 based on one or more preference(s) stored in association with a user profile 132 of the user 100. For example, the user profile 132 may indicate a type of the notification(s) 128 to output, as well as their associated intensity (e.g., volume, luminosity, etc.), duration, type, patterns, combinations thereof, etc. The wearable speech therapy device 102 may access the preference(s) as stored in the user profile 132 when outputting the notification(s) 128.

In an embodiment, the wearable speech therapy device 102 may store or have access to machine-learned (ML) model(s) 134. The ML model(s) 134 may be trained to identify the user speech 106, or behavior, and/or may be trained to analyze the audio data 104 and/or the sensor data 124 to determine whether the user speech 106 corresponds to atypical speech and/or behavior. In an embodiment, the ML model(s) 134 may determine the speech and/or vocal biomarkers 110 for determining whether the user speech 106 is associated with hypophonia. In an embodiment, the ML model(s) 134 may determine or generate score(s) associated with the audio data 104 and/or the sensor data 124, to determine whether the user speech 106 contains atypical speech and/or behavior. In an embodiment, the score(s) may relate to a probability or likelihood that the user speech 106 is associated with or contains atypical speech and/or behavior. In other words, the score(s) output by the ML model(s) 134 may be machine-learned scores.

Machine learning generally involves processing a set of examples (called “training data”) to train a machine learning model(s). A machine learning model(s), once trained, is a learned mechanism that can receive new data as input and estimate or predict a result as output. For example, a trained machine learning model may comprise a classifier that is tasked with classifying unknown input (e.g., an unknown audio) as one of multiple class labels. In some cases, a trained machine learning model is configured to implement a multi-label classification task. Additionally, or alternatively, a trained machine learning model may be trained to infer a probability or a set of probabilities, for a classification task based on unknown data received as input. In the context of the present disclosure, the unknown input may be the audio data 104 and/or the sensor data 124 that is associated with the user speech 106, and the ML model(s) 134 may be tasked with outputting the score that indicates or otherwise relates to, a probability of the user speech 106 containing atypical speech and/or behavior. Additionally, the scores may indicate or otherwise relate to a probability of the speech and/or vocal biomarkers 110 for determining whether the user speech 106 is associated with atypical speech and/or behavior such as hypophonia. Other data, such as behavior data of the user 100 may be provided as an input to the ML model(s) 134.

The training data that is used to train ML model(s) 134 may include various types of data. In general, training data for machine learning may include two components, features and labels. However, in an embodiment, the training data used to train the ML model(s) 134 may be unlabeled. Accordingly, the ML model (ors) 134 may be trainable using any suitable learning technique, such as supervised learning, unsupervised learning, semi-supervised learning, reinforcement learning, and so on. The features included in the training data may be represented by a set of features, such as in the form of an n-dimensional feature vector of quantifiable information about an attribute of the training data. The following is a list of example features that can be included in the training data for training the ML model(s) 134 described herein. However, it is to be appreciated that the following list of features is non-exhaustive, and features used in training may include additional features not described herein, and, in some cases, some, but not all, of the features listed herein. Example features included in the training data may include, without limitation, pitch, intonation, tone, pauses, phonation, changes associated with the user speech 106, articulation, decreased energy in the higher parts of a harmonic spectrum, imprecise articulation of vowels and consonants, fundamental frequency, voicing, windowed and absolute syllable/sonorant-peak rates, SNR, temporal and spectral voice characteristics, frequency, spectral/cepstral cues, vocal quality/stability, prosody, temporal output, and amplitude stability, and/or motor processes. In an embodiment, the features included within the training data may be associated with user speech that contains atypical speech and/or behavior and/or user speech that does not contain atypical speech and/or behavior.

In an embodiment, as part of the training process, weights may be applied to a set of features included in the training data, as derived from the historical data. In an embodiment, the weights that are set during the training process may apply to parameters that are internal to the ML model(s) 134 (e.g., weights for neurons in a hidden-layer of a neural network). These internal parameters of the ML model(s) 134 may or may not map one-to-one with individual input features of the set of features. The weights may indicate the influence that any given feature, parameter, or characteristic has on the score that is output by the ML model(s) 134.

The ML model(s) 134 may represent a single model or an ensemble of base-level machine learning models and may be implemented as any type of machine learning model. For example, suitable machine learning models for use with the techniques and systems described herein include, without limitation, neural networks, tree-based models, support vector machines (SVMs), kernel methods, random forests, splines (e.g., multivariate adaptive regression splines), hidden Markov model (HMMs), Kalman filters (or enhanced Kalman filters), Bayesian networks (or Bayesian belief networks), expectation maximization, genetic algorithms, linear regression algorithms, nonlinear regression algorithms, logistic regression-based classification models, or an ensemble thereof. An “ensemble” can comprise a collection of machine learning models whose outputs (predictions) are combined, such as by using weighted averaging or voting. The individual machine learning models of an ensemble can differ in their expertise, and the ensemble can operate as a committee of individual machine learning models that is collectively “smarter” than any individual machine learning model of the ensemble.

In an embodiment, and as noted above, the ML model(s) 134 may identify or determine the characteristic(s) 108, such as the speech and/or vocal biomarkers 110, for comparison against the reference characteristic(s). The ML model(s) 134 may learn to identify complex relationships between the speech and/or vocal biomarkers 110, user data, etc. for determining whether the user speech 106 is associated with atypical speech and/or behavior. For example, the ML model(s) 134 may learn to associate certain speech and/or vocal biomarkers 110 with whether the user speech 106 includes or is free from atypical speech and/or behavior.

In an embodiment, the ML model(s) 134 may learn to predict that the user speech 106 contains atypical speech and/or behavior by attributing corresponding score(s) to the user speech 106. In this manner, user speech 106 with low scores, for example, (e.g., below threshold) may not include atypical speech and/or behavior, or the speech and/or vocal biomarkers 110 may not be indicative of atypical speech and/or behavior, while the user speech 106 with high scores (e.g., above threshold) may hypophonia. Although the use of a threshold is described as one example way of providing labeling (i.e., replaced or maintained), other techniques are contemplated, such as clustering algorithms, or other statistical approaches that use the trust scores may be used. The ML model(s) 134 is/are retrainable with new data to adapt the ML model(s) 134.

In addition to processing the audio data 104 and/or the sensor data 124 to detect atypical speech and/or behavior, the wearable speech therapy device 102 may utilize other data. For example, the wearable speech therapy device 102 may have access to user data stored within the user profile 132. The user data may indicate demographics of the user 100, environmental factors, a schedule of the user 100, medications of the user 100, etc. This user data may additionally, or alternatively be used to treat, detect, manage, and/or prevent atypical speech and/or behavior. For example, incorporating user-specific, treatment-related, non-vocal data may be used to more effectively treat, manage, and/or prevent atypical speech and/or behavior. In an embodiment, the speech and/or vocal biomarkers 110 may be determined via a correlation with the user data.

The speech and/or vocal biomarkers 110 may be stored in association with the user profile 132. The user profile 132 may also store the audio data 104. Such data may be used by the user 100, care provider, and/or a speech pathologist to further refine therapeutic benefits made possible by the wearable speech therapy device 102. The audio data 104 and/or sensor data 124 may also be stored in the memory 114 of the wearable speech therapy device 102 and provided (e.g., downloaded) to other devices.

As shown, the wearable speech therapy device 102 may be communicatively coupled to one or more devices, such as a mobile device 136 and/or remote computing resource(s) 138 over network(s) 140. The network(s) 140 may include any viable communication technology, such as wired and/or wireless modalities and/or technologies. The network(s) 140 may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed—and/or any combination, permutation, and/or aggregation thereof. The wearable speech therapy device 102 includes suitable network interface(s) 142 for communicating over the network(s) 140.

In an embodiment, the mobile device 136 may process the audio data 104 and/or the sensor data 124 to determine the speech and/or vocal biomarkers 110 for detecting atypical speech and/or behavior. The wearable speech therapy device 102 may send the audio data 104 and/or the sensor data 124 to the mobile device 136 for processing, and the mobile device 136 may transmit notifications back to the wearable speech therapy device 102 for output. Microphone(s) and/or sensor(s) of the mobile device 136 may additionally or alternatively be used to detect atypical speech and/or behavior. Additionally, the wearable speech therapy device 102 and/or the mobile device 136 may communicatively couple to the remote computing resource(s) 138 for processing the audio data 104 and/or the sensor data 124. Any level of split processing may be performed by the wearable speech therapy device 102, the mobile device 136, the remote computing resource(s) 138, and/or other devices, systems, networks, etc.

Although described herein as being a wearable device worn on the user 100, in an embodiment, the techniques described herein for treating, detecting, managing, and/or preventing hypophonia may not be limited to such wearable devices. For example, non-wearable devices may employ the techniques described herein.

The remote computing resource(s) 138 may be implemented as one or more servers and may, in an embodiment, form a portion of a network-accessible computing platform implemented as a computing infrastructure of processors, storage, software, data access, etc. that is maintained and accessible via a network such as the Internet. The remote computing resource(s) 138 does not require end-user knowledge of the physical location and configuration of the system that delivers the services. Common expressions associated with the remote computing resource(s) 138 may include “on-demand computing”, “software as a service (SaaS)”, “platform computing”, “network-accessible platform”, “cloud services”, “data centers”, etc.

As used herein, a processor, such as the processor(s) 112 may include multiple processors and/or a processor having multiple cores. Further, the processor(s) 112 may comprise one or more cores of different types. For example, the processor(s) 112 may include application processor units, graphic processing units, and so forth. In one implementation, the processor(s) 112 may comprise a microcontroller and/or a microprocessor. The processor(s) 112 may include a graphics processing unit (GPU), a microprocessor, a digital signal processor or other processing units or components known in the art. Alternatively, or in addition, the functionally described herein can be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 112 may possess its own local memory, which also may store program components, program data, and/or one or more operating systems.

Memory, such as the memory 114 may include volatile and nonvolatile memory, removable and non-removable media implemented in any method or technology for storage of information, such as computer-readable instructions, data structures, program component, or other data. Such memory may include but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device. The memory may be implemented as computer-readable storage media (“CRSM”), which may be any available physical media accessible by the processor(s) to execute instructions stored on the memory. In one basic implementation, CRSM may include random access memory (“RAM”) and Flash memory. In other implementations, CRSM may include but is not limited to, read-only memory (“ROM”), electrically erasable programmable read-only memory (“EEPROM”), or any other tangible medium that can be used to store the desired information and which can be accessed by the processor(s) 112. The memory 114 is an example of non-transitory computer-readable media. The memory 114 may store an operating system and one or more software applications, instructions, programs, and/or data to implement the methods described herein and the functions attributed to the various systems.

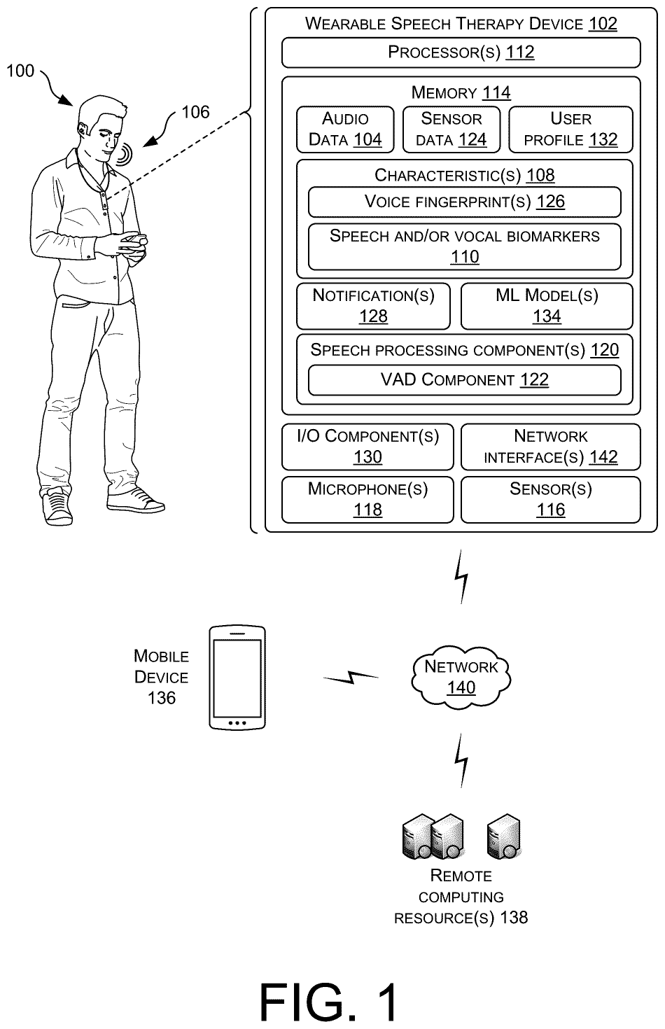

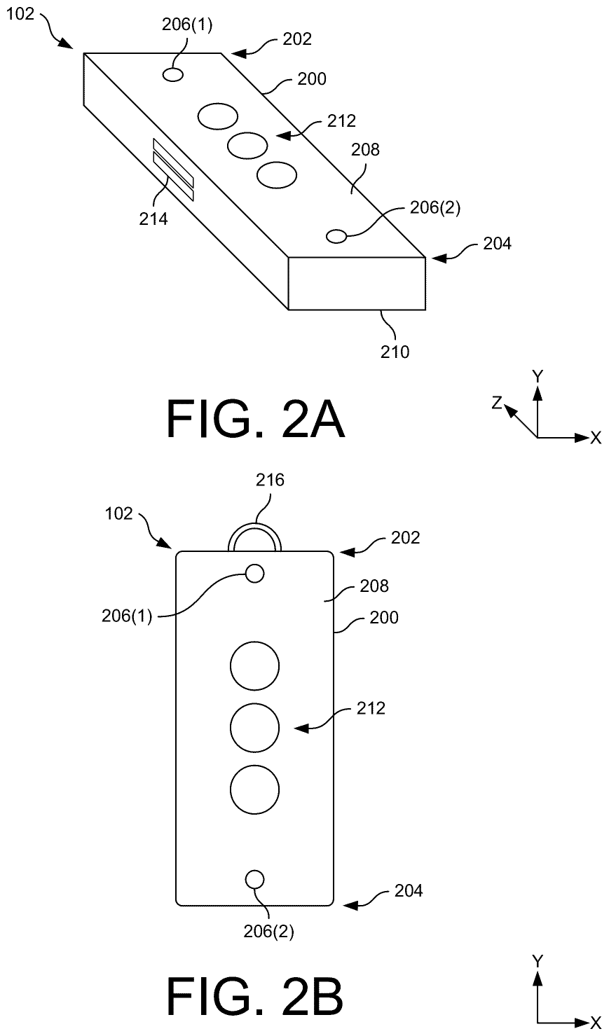

FIGS. 2A and 2B illustrate various views of the wearable speech therapy device 102, according to examples of the present disclosure. In an embodiment, the wearable speech therapy device 102 may be a compact device worn on a body of the user 100. For example, the wearable speech therapy device 102 may be worn in any manner on the user 100 such as in the form of bracelets, watches, stick-on arrays, eyeglasses, caps, hearing aids, brooches, ties, lanyards, earrings, etc. The wearable speech therapy device 102 may include suitable attachment mechanisms, such as hook and loop, clasps, magnets, cords, chains, etc. for coupling (e.g., pinning, hanging, etc.) in any manner to the user 100. As illustrated and as discussed in FIG. 1, the wearable speech therapy device 102 may be worn around a neck of the user 100 (e.g., via a lanyard, for example).

The wearable speech therapy device 102 may include a housing 200 in which components of the wearable speech therapy device 102 are disposed. The housing 200 may include any shape, such as an elongated cylindrical housing. The housing 200 may be manufactured from any suitable materials, such as plastics, composites, metal, etc., and using any manufacturing processes, such as injection molding, stamping, blow molding, etc. The housing 200 may also be water-resistant to prevent the ingress of contaminates into the housing. Internal components are disposed within the housing 200, such as the microphone(s) 118, sensor(s) 116, processor(s) 112, rigid or flexible PCBs that may be stand-alone or embedded or integrated, battery, etc.

The housing 200 may include a first end 202 and a second end 204 spaced apart from the first end 202 (e.g., in the Z-direction). The first end 202, when worn by the user 100, may be disposed closer to the mouth of the user 100 as compared to the second end 204. For example, the housing 200 may hang from the first end 202, via a lanyard (not shown), coupling to an attachment mechanism 216 (e.g., clasp, hoop, etc.). When worn, the housing 200 (or more generally the wearable speech therapy device 102) may be vertically disposed relative to an anatomical axis of the user 100. The microphone(s) 118 and the mouth of the user 100 may be positioned along approximately a straight line, with one of the microphone(s) 118 being located nearer to the mouth than the other. The first of the microphone(s) 118 may be located closer to the first end 202 as compared to the second of the microphone(s) 118, while the second of the microphone(s) 118 may be located closer to the second end 204 as compared to the first end 202. The microphone(s) 118 may be located along a central axis of the wearable speech therapy device 102 (e.g., between the first end 202 and the second end 204).

Sound may be routed to the microphone(s) 118, respectively, via port(s) 206 disposed through the housing 200. The port(s) 206 may route sound to other sensor(s) 116. For example, the housing 200 may include a front surface 208 that defines the port(s) 206. A first of the port(s) 206 may channel sound to the first of the microphone(s) 118, while a second of the port(s) 206 may channel sound to the second of the microphone(s) 118. Additionally, the port(s) 206 may also be sealed or covered with an acoustic mesh or membrane material that prevents or substantially prevents the ingress of water or moisture into the interior of the wearable speech therapy device 102, while allowing sound to permeate there through and reach the microphone(s) and/or sensor(s) 116. For example, in an embodiment, the mesh or membrane material may include polytetrafluoroethylene (PTFE), silicone rubber, metal, and/or a combination thereof. Although the port(s) 206 are described and shown as being defined by the front surface 208 of the housing 200, the port(s) 206 may be disposed on other sides, surface(s), etc. of the housing 200.

When worn by the user 100, a back surface 210 of the housing 200 may be disposed against the body of the user 100. As the back surface 210 may be in contact (e.g., rest against, abut, etc.) the body of the user 100, the sensor(s) 116 may be arranged to detect the user speech 106, for example, based on experienced vibrations, accelerations, inhaling/exhaling, pressure changes, and so forth. Additionally, although a particular disposition of the wearable speech therapy device 102 is described when worn by the user 100, the wearable speech therapy device 102 may be horizontally or vertically disposed on the user 100.

The wearable speech therapy device 102, as discussed above, may include I/O component(s) 130. For example, the wearable speech therapy device 102 may include lighting element(s) 212 that output light. The lighting element(s) 212 may output the notification(s) 128 associated with providing feedback to the user 100. The lighting element(s) 212 may output any combination of light, color, intensity, etc. As shown, the wearable speech therapy device 102 may include three of the lighting element(s) 212, however, more than or less than three of the lighting element(s) 212 may be included. Additionally, although the lighting element(s) 212 are shown being located on the front surface 208, the lighting element(s) 212 may be located elsewhere. Additionally, the lighting element(s) 212 may be implemented as a LED strip, or LED bar, as compared to being separate lighting elements disposed through the housing 200.

The housing 200 may also define one or more orifices 214 through which sound is emitted via a speaker of the wearable speech therapy device 102. The one or more orifices 214 may be located along one or more sides of the housing 200. The speaker may output audio corresponding to the notification(s) 128 for providing feedback to the user 100. Mesh or other material may cover the one or more orifices 214 to allow sound to exit the wearable speech therapy device while at the same time, inhibiting the ingress of liquids, moisture, or debris.

In an embodiment, one or more button(s) may be included to control one or more operation(s) of the wearable speech therapy device 102. The button(s) may be used to power on/off the wearable speech therapy device 102, mute the wearable speech therapy device 102, change setting(s) of the wearable speech therapy device 102, connect to nearby devices, etc.

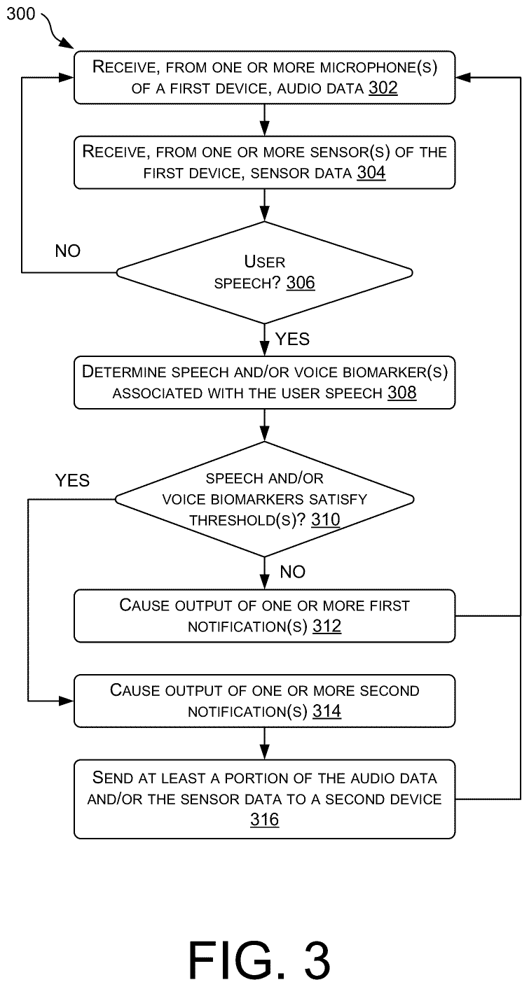

FIG. 3 illustrates an example process 300 (e.g., method) related to determining whether the user speech 106 is associated with atypical speech and/or behavior, according to examples of the present disclosure. The process 300 described herein is illustrated as collections of blocks in logical flow diagrams, which represent a sequence of operations or acts, some or all of which may be implemented in hardware, software, or a combination thereof. In the context of software, the blocks may represent computer-executable instructions stored on one or more computer-readable media that, when executed by one or more processors, program the processors to perform the recited operations or acts. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process 300 or alternative processes, and not all of the blocks need be executed. For discussion purposes, the process 300 is described with reference to the environments, devices, architectures, diagrams, and systems described in the examples herein, such as, for example those described with respect to FIGS. 1-2B, although the process 300 may be implemented in a wide variety of other environments, architectures, and systems.

At 302, the process 300 may include receiving audio data from one or more microphone(s) of a first device. For example, the wearable speech therapy device 102 may receive the audio data 104 as generated from the microphone(s) 118. In an embodiment, the audio data 104 may be at least partially processed or unprocessed (e.g., filtered). In an embodiment, rather than receiving audio data 104, the wearable speech therapy device 102 may receive audio signals.

At 304, the process 300 may include receiving sensor data from one or more sensor(s) of the first device. For example, the wearable speech therapy device 102 may receive the sensor data 124 as generated from the sensor(s) 116. In an embodiment, the sensor data 124 may be at least partially processed or unprocessed (e.g., filtered). In an embodiment, rather than receiving sensor data 124, the wearable speech therapy device 102 may receive sensor signals from the sensor(s) 116. The sensor(s) may include accelerometer(s), piezoelectric sensor(s), IMUs, etc.

At 306, the process 300 may include determining whether the audio data and/or the sensor data is indicative of user speech or relevant behavior. For example, while various sounds may be present within an environment, the audio data 104 and/or the sensor data 124 may be processed to determine when the sounds correspond to the user speech 106. As discussed herein, the wearable speech therapy device 102 may be configured to identify the user speech 106 to provide therapeutic feedback to the user 100. Accordingly, to provide the therapeutic feedback, the user speech 106 is first detected.

Any combination of the audio data 104 and/or the sensor data 124 may be used to determine whether the user is speaking. For example, the sensor data 124 may indicate vibrations, accelerations, inhaling/exhaling, pressure changes, and so forth. In an embodiment, the audio data 104 may be processed using VAD, TOA, etc. to determine whether the user 100 is speaking. If at 306 the process 300 determines that the user speech 106 was not detected, the process 300 may follow the “NO” route and loop to 302. Here, the wearable speech therapy device 102 may continue to receive the audio data 104 and/or the sensor data 124 for determining whether the user speech 106 was detected. Comparatively, if at 306 the process 300 determines that the user speech 106 was detected, the process 300 may follow the “YES” route and proceed to 308.

At 308, the process 300 may include determining speech and/or vocal biomarker(s) associated with the user speech. For example, if the user speech 106 was detected, the process 300 may include determining the speech and/or vocal biomarker(s). In an embodiment, the speech and/or vocal biomarker(s) may be associated with determining whether the user speech is associated with atypical speech and/or behavior. Any number of the speech and/or vocal biomarkers 110 may be determined. As non-limiting examples, the speech and/or vocal biomarkers 110 may include pitch of the user speech 106, intonations in the user speech 106, tones associated with the user speech 106, pauses in the user speech 106, phonations associated with the user speech 106, changes associated with the user speech 106, articulations associated with the user speech 106, decreased energy in the higher parts of a harmonic spectrum of the user speech 106, imprecise articulation of vowels and consonants of the user speech 106, fundamental frequency of the user speech 106, voicing, windowed and absolute syllable/sonorant-peak rates, SNR, temporal and spectral voice characteristics, frequency, spectral/cepstral cues, vocal quality/stability, prosody, temporal output, and amplitude stability, and/or motor processes. In an embodiment, the speech and/or vocal biomarkers 110 may be associated with detecting low-amplitude speech or atypical speech and/or behavior.

In an embodiment, ML model(s) 134 may be used to process the audio data 104 and/or the sensor data 124 for determining the speech and/or vocal biomarkers 110. For example, the ML model(s) 134 may be previously trained to determine the speech and/or vocal biomarkers 110. In an embodiment, the ML model(s) 134 may receive the audio data 104 and/or the sensor data 124 as an input, and output an indication associated with whether the audio data 104 and/or the sensor data 124 are indicative of the speech and/or vocal biomarkers 110. In an embodiment, the ML model(s) 134 may output a score associated with the speech and/or vocal biomarkers 110, where the score may indicate likelihood or probability of the user speech containing the speech and/or vocal biomarkers 110.

At 310, the process 300 may include determining whether the speech and/or vocal biomarker(s) satisfy threshold(s). For example, the speech and/or vocal biomarkers 110 may be compared to reference speech and/or vocal biomarker(s), or characteristic(s) that are indicative of atypical speech and/or behavior. Any number of the speech and/or vocal biomarkers 110 may be considered when determining whether the user speech 106 contains atypical speech and/or behavior. In an embodiment, the ML model(s) may be used for determining whether the speech and/or vocal biomarkers 110 are indicative of satisfying threshold(s) associated with the user speech 106 containing atypical speech and/or behavior.

As non-limiting examples, the speech and/or vocal biomarkers 110 may be associated a pitch, amplitude, and/or tone associated with the user speech 106, and the pitch, amplitude, and/or tone may be compared to respective threshold(s). Based on such comparison, for example, the process 300 may determine whether the pitch, amplitude, tone, etc. are indicative of atypical speech and/or behavior. If at 310 the process 300 determines that the speech and/or vocal biomarkers 110 do not satisfy the threshold(s), the process 300 may follow the “NO” route and proceed to 312.

At 312, the process 300 may include causing output of one or more first notification(s). For example, the I/O component(s) 130 of the wearable speech therapy device 102 may output notification(s) 128, where the notification(s) 128 may indicate that the user speech 106 does not contain atypical speech and/or behavior. For example, the lighting element(s) 212 may illuminate green, the speaker(s) may output audio tones, and so forth. In an embodiment, the first notification(s) may indicate that the user 100 is speaking properly, for example, as a way to provide feedback to the user 100 that their speech is correct and does not include indications of atypical speech and/or behavior. From 312, the process 300 may proceed to 302, whereby the process 300 may continue to receive the audio data 104 and/or the sensor data 124 for determining whether the user speech 106 is indicative of atypical speech and/or behavior.

Returning to 310, if the process 300 determines that the speech and/or vocal biomarker(s) satisfy the threshold(s), the process 300 may follow the “YES” route and proceed to 314. At 314, the process 300 may include causing output of one or more second notification(s). For example, the I/O component(s) 130 of the wearable speech therapy device 102 may output notification(s) 128, where the notification(s) 128 may indicate that the user speech 106 contains atypical speech and/or behavior. For example, the lighting element(s) 212 may illuminate red, the speaker(s) may output audio tones, and so forth. In an embodiment, the second notification(s) may be different than the first notification(s) as a way to signal to the user 100 to correct their speech. In this manner, the second notification(s) may provide feedback to the user 100 to enable the user 100 to correct their speech.

At 316, the process 300 may include sending at least a portion of the audio data and/or the sensor data to a second device. For example, the wearable speech therapy device 102 may send the audio data 104 and/or the sensor data 124 and/or the sensor data 124 to the mobile device 136 and/or the remote computing resource(s) 138. In an embodiment, the mobile device 136 and/or the remote computing resource(s) 138 may further process the audio data 104 and/or the sensor data 124, may store/log the audio data 104 and/or the sensor data 124 to maintain a history of the user speech 106 associated with the user 100, etc. From 316, the process 300 may loop to 302, whereby the wearable speech therapy device 102 may continue to process and analyze the user speech 106.

While various examples and embodiments are described individually herein, the examples and embodiments may be combined, rearranged, and modified to arrive at other variations within the scope of this disclosure.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A wearable speech therapy device to be worn by a user, the wearable speech therapy device comprising:
a housing including a first end and a second end spaced apart from the first end;
a first microphone located closer to the first end than the second end;
a second microphone located closer to the second end than the first end;
a speaker;
one or more processors; and
one or more non-transitory computer-readable media storing computer-executable instructions that, when executed by the one or more processors, cause the wearable speech therapy device to perform acts comprising:
receiving, from the first microphone, first audio data associated with audio captured within an environment,
receiving, from the second microphone, second audio data associated with the audio,
determining, based at least in part on the first audio data and the second audio data, that the audio is associated with user speech of the user within the environment,
determining, based at least in part on the audio being associated with the user speech, one or more biomarkers associated with the user speech,
determining that the one or more biomarkers satisfy a threshold associated with the user speech containing hypophonia, and
causing, based at least in part on the one or more biomarkers satisfying the threshold, output of a notification via the speaker.

2. The wearable speech therapy device of claim 1, the acts further comprising:
receiving, from the first microphone, third audio data associated with second audio captured within the environment;
receiving, from the second microphone, fourth audio data associated with the second audio;
determining, based at least in part on the third audio data and the fourth audio data, that the second audio is associated with second user speech of the user;
determining, based at least in part on the second audio being associated with the second user speech, one or more second biomarkers associated with the second user speech;
determining that the one or more second biomarkers fail to satisfy the threshold associated with the second user speech containing hypophonia; and
causing, based at least in part on the one or more second biomarkers failing to satisfy the threshold, output of a second notification via the speaker, the second notification being different than the notification.

3. The wearable speech therapy device of claim 1, further comprising at least one of a lighting element or a haptic motor, the acts further comprising causing at least one of a second notification to be output on the at least one of the lighting element or the haptic motor.

4. The wearable speech therapy device of claim 1, further comprising a sensor, the acts further comprising receiving, from the sensor, sensor data, wherein:
determining that the audio corresponds to the user speech is based at least in part on the sensor data; and
determining the one or more biomarkers is based at least in part on the sensor data.

5. The wearable speech therapy device of claim 1, wherein when the wearable speech therapy device is worn by the user, the first microphone and the second microphone are substantially aligned with an anatomical axis of the user.

6. The wearable speech therapy device of claim 1, wherein determining the one or more biomarkers is based at least in part on:
providing, as an input to a machine-learned (ML) model trained to identify hypophonia, the first audio data and the second audio data; and
receiving, as an output from the ML model, an indication associated with the one or more biomarkers.

7. The wearable speech therapy device of claim 1, wherein the one or more biomarkers include at least one of a pitch of the user speech, an intonation in the user speech, a tone associated with the user speech, a pause in the user speech, a phonation associated with the user speech, or an amplitude of the user speech.

8. A speech therapy device comprising:
one or more sensors;
one or more output components;
one or more processors; and
one or more non-transitory computer-readable media storing computer-executable instructions that, when executed by the one or more processors, cause the speech therapy device to perform acts comprising:
receiving, from the one or more sensors, data,
determining that the data is indicative of speech of a user,
determining, based at least in part on the data being indicative of the speech, one or more biomarkers associated with the speech, the one or more biomarkers including at least an amplitude associated with the speech,
determining that the one or more biomarkers fail to satisfy a threshold, and
causing, based at least in part on the one or more biomarkers failing to satisfy the threshold, output of a notification via the one or more output components.

9. The speech therapy device of claim 8, wherein the one or more sensors comprise:
at least one microphone; and
at least one of an internal measurement unit (IMU), an accelerometer, a gyroscope, or a piezoelectric sensor.

10. The speech therapy device of claim 8, wherein the one or more output components comprise at least one of:
a lighting element;
a speaker; or
a haptic motor.

11. The speech therapy device of claim 8, the acts further comprising:
receiving, from the one or more sensors, second data;
determining that the second data is indicative of second speech of the user;
determining, based at least in part on the second data being indicative of the second speech, one or more second biomarkers associated with the second speech, the one or more second biomarkers including at least a second amplitude associated with the second speech;
determining that the one or more second biomarkers satisfy the threshold associated with hypophonia; and
causing, based at least in part on the one or more second biomarkers satisfying the threshold, output of a second notification via the one or more output components, the second notification being different than the notification.

12. The speech therapy device of claim 11, the acts further comprising:
receiving, from the one or more sensors, third data;
determining that the third data is indicative of third speech of the user;
determining, based at least in part on the third data being indicative of the third speech, one or more third biomarkers associated with the third speech, the one or more third biomarkers including at least a third amplitude associated with the third speech;
determining that the one or more third biomarkers fail to satisfy the threshold associated with hypophonia; and
causing, based at least in part on the one or more third biomarkers failing to satisfy the threshold, output of the notification via the one or more output components.

13. The speech therapy device of claim 8, wherein the one or more biomarkers further include at least one of a pitch of the speech, an intonation in the speech, a tone associated with the speech, a pause in the speech, or a phonation associated with the speech.

14. The speech therapy device of claim 8, wherein determining the one or more biomarkers is based at least in part on:
providing, as an input to a machine-learned (ML) model trained to identify hypophonia data; and
receiving, as an output from the ML model, an indication associated with the one or more biomarkers.

15. The speech therapy device of claim 8, further comprising a housing including a first end and a second end, wherein:
the one or more sensors include a first microphone and a second microphone, the first microphone being locater closer to the first end as compared to the second microphone, the second microphone being located closer to the second end as compared to the first microphone; and
when the speech therapy device is worn by the user, the first microphone is located closer to a mouth of the user as compared to the second microphone.

16. A speech therapy device configured to be worn by a user, the speech therapy device comprising:
a first microphone;
a second microphone;
one or more output components;
one or more processors; and
one or more non-transitory computer-readable media storing computer-executable instructions that, when executed by the one or more processors, cause the speech therapy device to perform acts comprising:
receiving, from the first microphone, first audio data associated with a sound captured in an environment,
receiving, from the second microphone, second audio data associated with the sound,
determining, based at least in part on the first audio data and the second audio data, that the sound is associated with user speech of the user,
determining, based at least in part on the sound being associated with the user speech, one or more characteristics associated with the user speech,
determining that the one or more characteristics are indicative of hypophonia, and
causing, based at least in part on the one or more characteristics being indicative of hypophonia, output of a notification via the one or more output components.

17. The speech therapy device of claim 16, wherein the one or more output components comprise at least one of a speaker, a lighting element, or a haptic motor.

18. The speech therapy device of claim 16, further comprising one or more sensors that include at least one of an accelerometer, a gyroscope, an internal measurement unit (IMU), or a piezoelectric sensor, the acts further comprising receiving, from the one or more sensors, data, wherein:
determining that the sound is associated with the user speech is based at least in part on the data; and
determining the one or more characteristics associated with the user speech is based at least in part on the data.

19. The speech therapy device of claim 16, the acts further comprising:
receiving, from the first microphone, third audio data associated with a second sound captured in the environment;
receiving, from the second microphone, fourth audio data associated with the second sound,
determining, based at least in part on the third audio data and the fourth audio data, that the second sound is associated with second user speech of the user,
determining, based at least in part on the second sound being associated with the second user speech of the user, one or more second characteristics associated with the second user speech;
determining that the one or more second characteristics are not indicative of hypophonia; and
causing, based at least in part on the one or more second characteristics not being indicative of hypophonia, output of a second notification via the one or more output components, the second notification being different than the notification.

20. The speech therapy device of claim 16, wherein the one or more characteristics comprise at least one of a pitch of the user speech, an intonation in the user speech, a tone associated with the user speech, a pause in the user speech, a phonation associated with the user speech, an amplitude of the user speech.
